(19) United States
(12) Patent Application Publication
(10) Pub. No.: US 2012/0224253 A1
(43) Pub. Date: Sep. 6, 2012

(54) DISTRIBUTED RAMAN AMPLIFICATION APPARATUS, DISTRIBUTED RAMAN AMPLIFICATION METHOD, AND NON-TRANSITORY COMPUTER READABLE MEDIUM STORING DISTRIBUTED RAMAN AMPLIFICATION PROGRAM

(75) Inventor: Kiyoto KOBAYASHI, Tokyo (JP)

(73) Assignee: NEC Corporation, Tokyo (JP)

(21) Appl. No.: 13/407,646

(22) Filed: Feb. 28, 2012

(30) Foreign Application Priority Data
Mar. 1, 2011 (JP) 2011-044079

(51) Int. Cl. H01S 3/30

(52) U.S. Cl. 359/334

(57) ABSTRACT

A distributed Raman amplification apparatus includes a Raman excitation light source that outputs Raman excitation light to a transmission line fiber through which signal light propagates, a light source control unit that controls an output wavelength of the Raman excitation light source to prevent the Raman excitation light from changing a wavelength spectrum of the signal light, an intensity measurement unit that measures intensity of the Raman excitation light before and after propagation through the transmission line fiber, and a loss calculation unit that calculates a loss of the Raman excitation light in the transmission line fiber based on the intensity of the Raman excitation light before and after propagation through the transmission line fiber measured by the intensity measurement unit. This allows real-time monitoring of the Raman gain.

### INCORPORATION BY REFERENCE

This application is based upon and claims the benefit of priority from Japanese patent application No. 2011-044079, filed on Mar. 1, 2011, the disclosure of which is incorporated herein in its entirety by reference.

### BACKGROUND OF THE INVENTION

1. Technical Field

The present invention relates to distributed Raman amplification technology that Raman-amplifies signal light.

2. Background Art

Optical fiber amplification technology and distributed Raman amplification technology are known as technology for amplifying signal light. The distributed Raman amplification technology allows higher flexibility of the amplification waveband than the optical fiber amplification technology, thus being useful amplification technology. The distributed Raman amplification technology supplies Raman excitation light of a shorter wavelength than signal light to a transmission line and transfers the energy of the Raman excitation light to the signal light using Raman scattering effect, thereby enabling amplification of the signal light and a decrease in transmission loss of the signal light.

Use of the distributed Raman amplification technology leads to a decrease in apparent loss of a transmission line and improvement of OSNR (Optical Signal to Noise Ratio), thus achieving longer distance transmission. The distributed Raman amplification technology is disclosed in International Patent Publication No. WO2004/091121, Japanese Unexamined Patent Publication No. 2004-240278, Japanese Unexamined Patent Publication No. 2006-287249, Japanese Unexamined Patent Publication No. 2010-097185 and the like.

However, it is unable to monitor the Raman gain in real time in the situation where the signal light is supplied to the transmission line. This is because the transmission line loss varies depending on the physical conditions (temperature, tension, bending) of the transmission line, and therefore the variation of transmission line loss and the variation of Raman gain cannot be isolated from each other only by monitoring the signal power at the front and hack fiber, which is an amplification medium.

One approach is to monitor the Raman gain in the situation where the signal light is not supplied to the transmission line to thereby eliminate the contribution of variation of transmission line loss and extract the contribution of variation of Raman gain. It then controls the intensity of Raman excitation light based on the monitoring result of Raman gain in the situation where the signal light is supplied to the transmission line, thereby obtaining the desired Raman gain and the desired signal light intensity.

In short, although the Raman gain of the transmission line can be calculated at startup as disclosed in Japanese Unexamined Patent Publication No. 2010-097185, the Raman gain of the transmission line cannot be monitored in real time after startup. Accordingly, if the variation of transmission line loss occurs after startup and beginning of operation, the variation of Raman gain cannot be dealt with. For this reason, a wide margin of transmission design is provided in order to deal with the variation of transmission line loss and the variation of Raman gain, this fails to make the most of the advantage of distributed Raman amplification.

### SUMMARY

In light of the foregoing, an exemplary object of the invention is to provide a technique that allows real-time monitoring of the Raman gain.

In a first exemplary aspect of the invention, a distributed Raman amplification apparatus includes a Raman excitation light source that outputs Raman excitation light to a transmission line fiber through which signal light propagates, a light source control unit that controls an output wavelength of the Raman excitation light source to prevent the Raman excitation light from changing a wavelength spectrum of the signal light, an intensity measurement unit that measures intensity of the Raman excitation light before and after propagation through the transmission line fiber, and a loss calculation unit that calculates a loss of the Raman excitation light in the transmission line fiber based on the intensity of the Raman excitation light before and after propagation through the transmission line fiber measured by the intensity measurement unit.

In a second exemplary aspect of the invention, a distributed Raman amplification method includes a wavelength control step of controlling an output wavelength of Raman excitation light to prevent the Raman excitation light from changing a wavelength spectrum of signal light, an excitation light output step of outputting the Raman excitation light with the output wavelength controlled in the wavelength control step to a transmission line fiber through which the signal light propagates, an intensity measurement step of measuring intensity of the Raman excitation light before and after propagation through the transmission line fiber, and a loss calculation step of calculating a loss of the Raman excitation light in the transmission line fiber based on the intensity of the Raman excitation light before and after propagation through the transmission line fiber measured in the intensity measurement step.

In a third exemplary aspect of the invention, a non-transitory computer readable medium storing a distributed Raman amplification program causes a computer to sequentially execute a wavelength control procedure of controlling an output wavelength of Raman excitation light to prevent the Raman excitation light from changing a wavelength spectrum of signal light, an excitation light output procedure of outputting the Raman excitation light with the output wavelength controlled in the wavelength control procedure to a transmission line fiber through which the signal light propagates, an intensity measurement procedure of measuring intensity of the Raman excitation light before and after propagation through the transmission line fiber, and a loss calculation procedure of calculating a loss of the Raman excitation light in the transmission line fiber based on the intensity of the Raman excitation light before and after propagation through the transmission line fiber measured in the intensity measurement procedure.

### BRIEF DESCRIPTION OF THE DRAWINGS

The above and other aspects, features, and advantages of the present invention will become more apparent from the following description of certain exemplary embodiments when taken in conjunction with the accompanying drawings, in which:

FIG. 1 is a view showing a configuration of a distributed Raman amplification apparatus according to a first exemplary embodiment;

FIG. 2 is a view showing a process of the distributed Raman amplification apparatus according to the first exemplary embodiment;

FIG. 3 is a view showing a configuration of a distributed Raman amplification apparatus according to a second exemplary embodiment;

FIG. 4 is a view showing a process of the distributed Raman amplification apparatus according to the second exemplary embodiment.

### EXEMPLARY EMBODIMENT

Exemplary embodiments of the present invention will be described hereinafter with reference to the appended drawings. The explanation provided hereinbelow merely illustrates the exemplary embodiments of the present invention, and the present invention is not limited to the below-described exemplary embodiments. Note that, in this specification and the drawings, the identical reference symbols denote identical structural elements.

### First Exemplary Embodiment

FIG. 1 shows a configuration of a distributed Raman amplification apparatus according to a first exemplary embodiment. A distributed Raman amplification apparatus 1 according to the first exemplary embodiment includes a Raman excitation light source 11, a light source control unit 12, an intensity measurement unit 13, and a loss calculation unit 14. A transmission line of the first exemplary embodiment includes a transmission line fiber 2, a signal light/excitation light multiplexer/demultiplexer 3, and a coupler 4.

The Raman excitation light source 11 outputs Raman excitation light to the transmission line fiber 2 through which signal light propagates. For example, the Raman excitation light source 11 outputs the Raman excitation light through the signal light/excitation light multiplexer/demultiplexer 3. The light source control unit 12 controls the output wavelength of the Raman excitation light source 11 to prevent the Raman excitation light from changing the wavelength spectrum of the signal light.

For example, the light source control unit 12 refers to the wavelength spectrum of wavelength-multiplexed signal light, and makes control not to include a wavelength band in use into the wavelength band in which Raman amplification acts and to include a wavelength band not in use into the wavelength band in which Raman amplification acts. Specifically, when the signal light is wavelength-multiplexed, a wavelength hand currently in use is not included into the wavelength hand in which Raman amplification acts, and a wavelength band currently not in use is included into the wavelength hand in which Raman amplification acts. Note, however, that in the wavelength hand currently not in use, signal light does not exist. Raman amplification does not substantially act, and the wavelength spectrum of signal light does not change.

The intensity measurement unit 13 measures the intensity of the Raman excitation light before and after propagation through the transmission line fiber 2. For example, the intensity measurement unit 13 measures the intensity of the Raman excitation light from the Raman excitation light source 11 as the intensity of the Raman excitation light before propagation through the transmission line fiber 2, and measures the intensity of the Raman excitation light from the coupler 4 as the intensity of the Raman excitation light after propagation through the transmission line fiber 2. The loss calculation unit 14 calculates the loss of the Raman excitation light in the transmission line fiber 2 based on the intensity of the Raman excitation light before and after propagation through the transmission line fiber 2 measured by the intensity measurement unit 13.

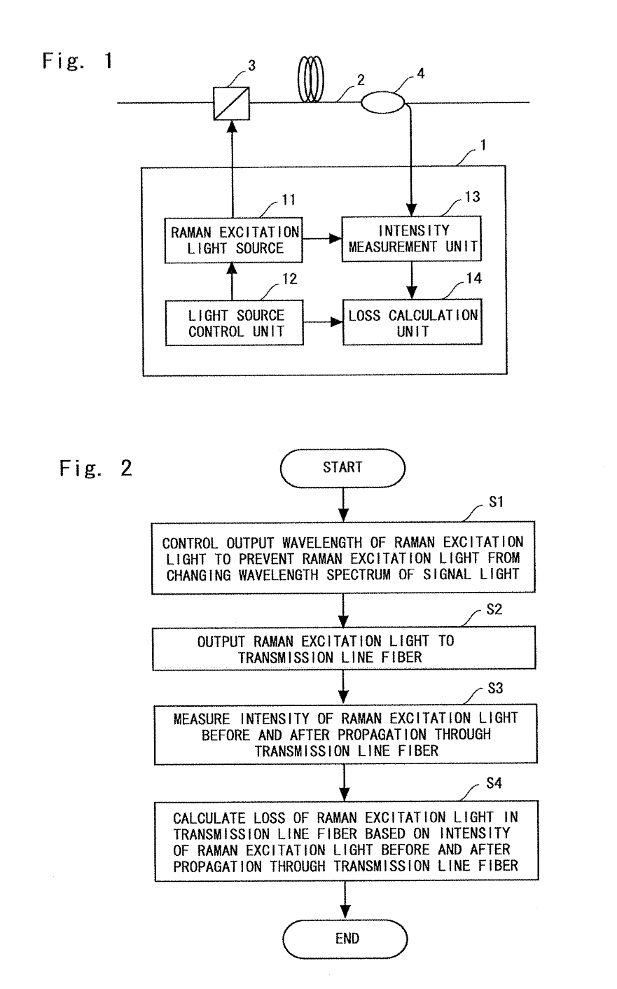

FIG. 2 shows a process of the distributed Raman amplification apparatus according to the first exemplary embodiment. In a wavelength control step, the ht source control unit 12 controls the output wavelength of Raman excitation light to prevent the Raman excitation light from changing the wavelength spectrum of signal light (Step S1). In an excitation light output step, the Raman excitation light source 11 outputs the Raman excitation light whose output wavelength has been controlled in the wavelength control step to the transmission line fiber 2 through which signal light propagates (Step S2).

In an intensity measurement step, the intensity measurement unit 13 measures the intensity of the Raman excitation light before and after propagation through the transmission line fiber 2 (Step S3). In a loss calculation step, the loss calculation unit 14 calculates the loss of the Raman excitation light in the transmission line fiber 2 based on the intensity of the Raman excitation light before and after propagation through the transmission line fiber 2 measured in the intensity measurement step (Step S4).

To execute the process described with reference to FIG. 2, a distributed Raman amplification program including a wavelength control procedure, an excitation light output procedure, an intensity measurement procedure and a loss calculation procedure may be installed into a computer.

As described above, the light source control unit 12 controls the output wavelength of the Raman excitation light source 11 to prevent the Raman excitation light from changing the wavelength spectrum of signal light. Consequently, before and after supply of the Raman excitation light to the transmission line fiber 2, the Raman gain varies, whereas the transmission line loss does not vary. Therefore, the distributed Raman amplification apparatus 1 can isolate the contribution of the Raman gain from the contribution of the transmission line loss and calculate the loss of the Raman excitation light in the transmission line fiber 2 in real time even when the signal light is supplied to the transmission line fiber 2, that is, after startup and beginning of operation. Further, the distributed Raman amplification apparatus 1 can control the Raman gain of the transmission line fiber 2 based on the calculated loss of the Raman excitation light in the transmission line fiber 2 as described below.

### Second Exemplary Embodiment

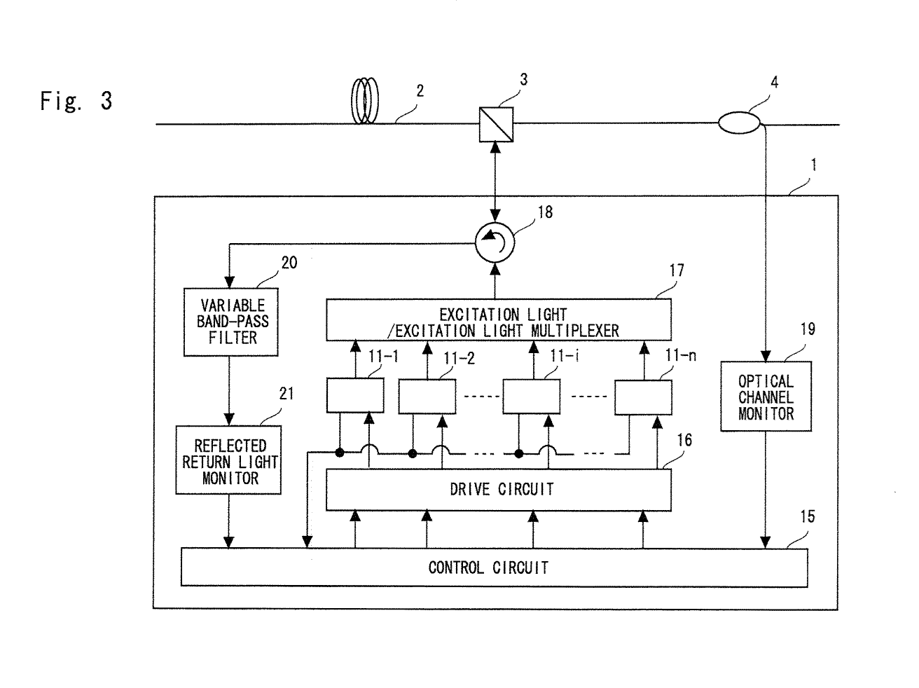

FIG. 3 shows a configuration of a distributed Raman amplification apparatus according to a second exemplary embodiment. A distributed Raman amplification apparatus 1 according to the second exemplary embodiment includes Raman excitation light sources 11-1, 11-2, . . . , 11-i, . . . , 11-n, a control circuit 15, a drive circuit 16, an excitation light/excitation light multiplexer 17, a circulator 18, an optical channel monitor 19, a variable band-pass filter 20, and a reflected return light monitor 21. A transmission line of the second exemplary embodiment includes a transmission line fiber 2, a signal light/excitation light multiplexer/demultiplexer 3, and a coupler 4.

The Raman excitation light sources 11-1, 11-2, . . . , 11-i, . . . 11-n output Raman excitation light to the transmission line fiber 2 through which wavelength-multiplexed signal light propagates. Specifically, the Raman excitation light sources 11-1, 11-2, . . . , 11-i, . . . , 11-n output Raman excitation light respectively having wavelengths λ1, λ2, . . . , λi, . . . , λn. The drive circuit 16 receives a control signal from the control circuit 15 and drives the Raman excitation light sources 11-1, 11-2, . . . , 11-i, . . . 11-n. The excitation light/excitation light multiplexer 17 receives the Raman excitation light from the Raman excitation light sources 11-1, 11-2, . . . , 11-i, . . . , 11-n and multiplexes the Raman excitation light.

Light that is supplied from the distributed Raman amplification apparatus 1 to the transmission line fiber 2 enters the transmission line fiber 2 on the left side of FIG. 3 through the circulator 18 and the signal light/excitation light multiplexer/demultiplexer 3. Return light that returns from the transmission line fiber 2 to the distributed Raman amplification apparatus 1 enters the variable hand-pass filter 20 through the signal light/excitation light multiplexer/demultiplexer 3 and the circulator 18. The wavelength-multiplexed signal light is transmitted through the transmission line fiber 2 from the left to the right of FIG. 3. Although a backward pumping system in which Raman excitation light is supplied from the back of the transmission line is employed in the second exemplary embodiment, a forward pumping system in which Raman excitation light is supplied from the front of the transmission line may be employed in another exemplary embodiment.

The optical channel monitor 19, serving as a wavelength spectrum measurement unit, receives the wavelength-multiplexed signal light through the coupler 4 and measures the wavelength spectrum of the wavelength-multiplexed signal light. The control circuit 15, serving as the light source control unit 12, controls the output wavelength of the Raman excitation light source 11 to prevent the Raman excitation light from changing the wavelength spectrum of the wavelength-multiplexed signal light based on the wavelength spectrum of the wavelength-multiplexed signal light measured by the optical channel monitor 19. Specifically, the control circuit 15 selects one to be driven by the drive circuit 16 among the Raman excitation light sources 11-1, 11-2, . . . , 11-i, . . . , 11-n.

The variable band-pass filter 20 tunes its passband to coincide with the output wavelength of the Raman excitation light source 11 based on the control of the control circuit 15 and thereby transmits the return light of the Raman excitation light. The reflected return light monitor 21, serving as the intensity measurement unit 13, measures the intensity of the Raman excitation light that has returned as return light from the transmission line fiber 2 as the intensity of the Raman excitation light after propagation through the transmission line fiber 2. The control circuit 15, serving as the intensity measurement unit 13, measures the intensity of the Raman excitation light that is output from the Raman excitation light source 11 as the intensity of the Raman excitation light before propagation through the transmission line fiber 2.

The control circuit 15, serving as the loss calculation unit 14, calculates the loss of the Raman excitation light in the transmission line fiber 2 based on the intensity of the Raman excitation light before and after propagation through the transmission line fiber 2 respectively measured by the control circuit 15 and the reflected return light monitor 21 serving as the intensity measurement unit 13. Specifically, the control circuit 15 calculates the loss of the Raman excitation light in the transmission line fiber 2 based on the relationship of the time difference return light and the intensity of return light according to the principle of OTDR (Optical Time Domain Reflectometer). The control circuit 15, serving as a Raman gain control unit, controls the Raman gain of the transmission line fiber 2 based on the loss of the Raman excitation light in the transmission line fiber 2 calculated by the control circuit 15 serving as the loss calculation unit 14.

The control circuit 15, serving as the light source control unit 12, may further modulate the intensity of the Raman excitation light. Then, the reflected return light monitor 21, serving as the intensity measurement unit 13, may measure the modulated intensity of the Raman excitation light after propagation through the transmission line fiber 2, and the control circuit 15, serving as the intensity measurement unit 13, may measure the modulated intensity of the Raman excitation light before propagation through the transmission line fiber 2. The control circuit 15, serving as the loss calculation unit 14, may calculate the loss of the Raman excitation light in the transmission line fiber 2 based on the modulated intensity of the Raman excitation light before and after propagation through the transmission line fiber 2 respectively measured by the control circuit 15 and the reflected return light monitor 21 serving as the intensity measurement unit 13.

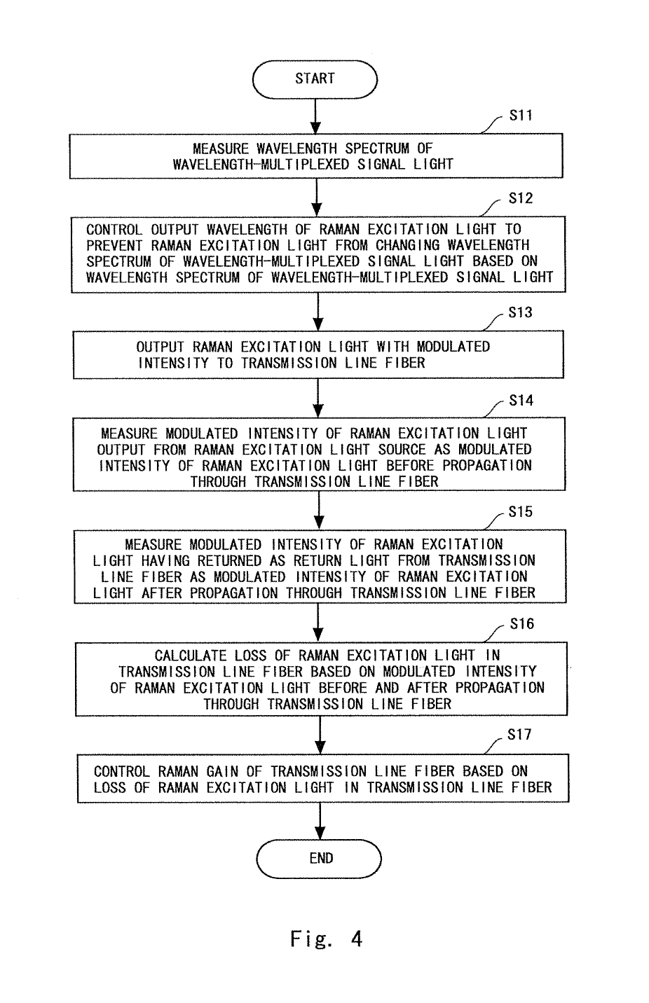

FIG. 4 shows a process of the distributed Raman amplification apparatus according to the second exemplary embodiment. In a wavelength spectrum measurement step, the optical channel monitor 19 measures the wavelength spectrum of wavelength-multiplexed signal light (Step S11). In a wavelength control step, the control circuit 15 controls the output wavelength of Raman excitation light to prevent the Raman excitation light from changing the wavelength spectrum of signal light based on the wavelength spectrum of the wavelength-multiplexed signal light measured in the wavelength spectrum measurement step (Step S12). In an excitation light output step, the Raman excitation light source 11 outputs the Raman excitation light whose output wavelength has been controlled in the wavelength control step to the transmission line fiber 2 through which the wavelength-multiplexed signal light propagates (Step S13).

In an intensity measurement step, the control circuit 15 measures the modulated intensity of the Raman excitation light that has been output in the excitation light output step as the modulated intensity of the Raman excitation light before propagation through the transmission line fiber 2 (Step S14). The reflected return light monitor 21 measures the modulated intensity of the Raman excitation light that has returned as return light from the transmission line fiber 2 as the intensity of the Raman excitation light after propagation through the transmission line fiber 2 (Step S15). The order of performing Steps S14 and S15 is not particularly limited.

In a loss calculation step, the control circuit 15 calculates the loss of the Raman excitation light in the transmission line fiber 2 based on the modulated intensity of the Raman excitation light before and after propagation through the transmission line fiber 2 measured in the intensity measurement step (Step S16). In a Raman gain control step, the control circuit 15 controls the Raman gain of the transmission line fiber 2 based on the loss of the Raman excitation light in the transmission line fiber 2 calculated in the loss calculation step (Step S17).

To execute the process described with reference to FIG. 4, a distributed Raman amplification program including a wavelength spectrum measurement procedure, a wavelength control procedure, an excitation light output procedure, an intensity measurement procedure, a loss calculation procedure and a Raman gain control procedure may be installed into a computer.

The control circuit 15 controls the Raman gain of the transmission line fiber 2 based on the calculated loss of the Raman excitation light in the transmission line fiber 2. Therefore, the distributed Raman amplification apparatus 1 can control the Raman gain of the transmission line fiber 2 in real time even when the signal light is supplied to the transmission line fiber 2, that is, after startup and beginning of operation.

The optical channel monitor 19 measures the wavelength spectrum of the wavelength-multiplexed signal light, and the control circuit 15 controls the output wavelength of the Raman excitation light source 11 to prevent the Raman excitation light from changing the wavelength spectrum of the wavelength-multiplexed signal light based on the wavelength spectrum of the wavelength-multiplexed signal light. Therefore, the distributed Raman amplification apparatus 1 can control the Raman gain of the transmission line fiber 2 in real time according to the wavelength spectrum of the signal light at the present time.

The distributed Raman amplification apparatus 1 may employ a method that modulates the intensity of Raman excitation light and calculates the loss of the Raman excitation light in the transmission line fiber 2 based on the modulated intensity of the Raman excitation light before and after propagation through the transmission line fiber 2 by the control circuit 15. Further, the distributed Raman amplification apparatus 1 may employ a method that calculates the loss of Raman excitation light in the transmission line fiber 2 based on the intensity of the Raman excitation light before propagation and the intensity of the Raman excitation light as return light according to the principle of OTDR.

### Alternative Example

In the second exemplary embodiment, an optical communication system that transmits wavelength multiplexed signal light with a plurality of wavelengths is assumed. In this alternative example, an optical communication system that transmits no wavelength multiplexed signal light with a single wavelength is assumed. In this optical communication system, one type of wavelength of Raman excitation light is used, and the wavelength of Raman excitation light is selected to prevent the Raman excitation light from changing the wavelength spectrum of signal light. In FIG. 3, the excitation light/excitation light multiplexer 17, the coupler 4 and the optical channel monitor 19 are not needed, and the variable band-pass filter 20 can be replaced with a fixed band-pass filter.

Each of the above-described embodiments can be combined as desirable by one of ordinary skill in the art.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

The whole or part of the exemplary embodiments disclosed above can be described as, but not limited to, the following supplementary notes.

### (Supplementary Note 1)

A distributed Raman amplification apparatus comprising:

a Raman excitation light source that outputs Raman excitation light to a transmission line fiber through which signal light propagates;

a light source control unit that controls an output wavelength of the Raman excitation light source to prevent the Raman excitation light from changing a wavelength spectrum of the signal light;

an intensity measurement unit that measures intensity of the Raman excitation light before and after propagation through the transmission line fiber; and

a loss calculation unit that calculates a loss of the Raman excitation light in the transmission line fiber based on the intensity of the Raman excitation light before and after propagation through the transmission line fiber measured by the intensity measurement unit.

### (Supplementary Note 2)

The distributed Raman amplification apparatus according to Supplementary note 1, further comprising:

a Raman gain control unit that controls a Raman gain of the transmission line fiber based on the loss of the Raman excitation light in the transmission line fiber calculated by the loss calculation unit.

### (Supplementary Note 3)

The distributed Raman amplification apparatus according to Supplementary note 1 or 2, further comprising:

a wavelength spectrum measurement unit that measures a wavelength spectrum of wavelength-multiplexed signal light,

wherein the light source control unit controls an output wavelength of the Raman excitation light source to prevent the Raman excitation light from changing the wavelength spectrum of the wavelength-multiplexed signal light based on the wavelength spectrum of the wavelength-multiplexed signal light measured by the wavelength spectrum measurement unit.

### (Supplementary Note 4)

The distributed Raman amplification apparatus according to any one of Supplementary notes 1 to 3, wherein

the light source control unit modulates the intensity of the Raman excitation light,

the intensity measurement unit measures the modulated intensity of the Raman excitation light before and after propagation through the transmission line fiber, and

the loss calculation unit calculates a loss of the Raman excitation light in the transmission line fiber based on the modulated intensity of the Raman excitation light before and after propagation through the transmission line fiber measured by the intensity measurement unit.

### (Supplementary Note 5)

The distributed Raman amplification apparatus according to any one of Supplementary notes 1 to 4, wherein the intensity measurement unit measures the intensity of the Raman excitation light output from the Raman excitation light source as the intensity of the Raman excitation light before propagation through the transmission line fiber, and measures the intensity of the Raman excitation light having returned as return light from the transmission line fiber as the intensity of the Raman excitation light after propagation through the transmission line fiber.

### (Supplementary Note 6)

A distributed Raman amplification method comprising:

a wavelength control step of controlling an output wavelength of Raman excitation light to prevent the Raman excitation light from changing a wavelength spectrum of signal light;

an excitation light output step of outputting the Raman excitation light with the output wavelength controlled in the wavelength control step to a transmission line fiber through which the signal light propagates;

an intensity measurement step of measuring intensity of the Raman excitation light before and after propagation through the transmission line fiber; and

a loss calculation step of calculating a loss of the Raman excitation light in the transmission line fiber based on the intensity of the Raman excitation light before and after propagation through the transmission line fiber measured in the intensity measurement step.

### (Supplementary Note 7)

The distributed Raman amplification method according to Supplementary note 6, further comprising, after the loss calculation step, a Raman gain control step of controlling a Raman gain of the transmission line fiber based on the loss of the Raman excitation light in the transmission line fiber calculated in the loss calculation step.

### (Supplementary Note 8)

The distributed Raman amplification method according to Supplementary note 6 or 7, further comprising, before the wavelength control step:

a wavelength spectrum measurement step of measuring a wavelength spectrum of wavelength-multiplexed signal light,

wherein the wavelength control step controls an output wavelength of the Raman excitation light to prevent the Raman excitation light from changing the wavelength spectrum of the wavelength-multiplexed signal light based on the wavelength spectrum of the wavelength-multiplexed signal light measured in the wavelength spectrum measurement step.

### (Supplementary Note 9)

The distributed Raman amplification method according to any one of Supplementary notes 6 to 8, wherein

the excitation ht output step modulates the intensity of the Raman excitation light,

the intensity measurement step measures the modulated intensity of the Raman excitation light before and after propagation through the transmission line fiber, and

the loss calculation step calculates a loss of the Raman excitation light in the transmission line fiber based on the modulated intensity of the Raman excitation light before and after propagation through the transmission line fiber measured in the intensity measurement step.

### (Supplementary Note 10)

The distributed Raman amplification method according to any one of Supplementary notes 6 to 9, wherein the intensity measurement step measures the intensity of the Raman excitation light output in the excitation light output step as the intensity of the Raman excitation light before propagation through the transmission line fiber, and measures the intensity of the Raman excitation light having returned as return light from the transmission line fiber as the intensity of the Raman excitation light after propagation through the transmission line fiber.

### (Supplementary Note 11)

A distributed Raman amplification program causing a computer to sequentially execute:

a wavelength control procedure of controlling an output wavelength of Raman excitation light to prevent the Raman excitation light from changing a wavelength spectrum of signal light;

an excitation light output procedure of outputting the Raman excitation light with the output wavelength controlled in the wavelength control procedure to a transmission line fiber through which the signal light propagates;

an intensity measurement procedure of measuring intensity of the Raman excitation light before and after propagation through the transmission line fiber; and

a loss calculation procedure of calculating a loss of the Raman excitation light in the transmission line fiber based on the intensity of the Raman excitation light before and after propagation through the transmission line fiber measured in the intensity measurement procedure.

### (Supplementary Note 12)

The distributed Raman amplification program according to Supplementary note 11, the program causing the computer to further execute, after the loss calculation procedure, a Raman gain control procedure of controlling a Raman gain of the transmission line fiber based on the loss of the Raman excitation light in the transmission line fiber calculated in the loss calculation procedure.

### (Supplementary Note 13)

The distributed Raman amplification program according to Supplementary note 11 or 12, the program causing the computer to further execute, before the wavelength control procedure:

a wavelength spectrum measurement procedure of measuring a wavelength spectrum of wavelength-multiplexed signal light,

wherein the wavelength control procedure controls an output wavelength of the Raman excitation light to prevent the Raman excitation light from changing the wavelength spectrum of the wavelength-multiplexed signal light based on the wavelength spectrum of the wavelength-multiplexed signal light measured in the wavelength spectrum measurement procedure.

### (Supplementary Note 14)

The distributed Raman amplification program according to any one of Supplementary notes 11 to 13, wherein

the excitation light output procedure modulates the intensity of the Raman excitation light,

the intensity measurement procedure measures the modulated intensity of the Raman excitation light before and after propagation through the transmission line fiber, and

the loss calculation procedure calculates a loss of the Raman excitation light in the transmission line fiber based on the modulated intensity of the Raman excitation light before and after propagation through the transmission line fiber measured in the intensity measurement procedure.

### (Supplementary Note 15)

The distributed Raman amplification program according to any one of Supplementary notes 11 to 14, wherein the intensity measurement procedure measures the intensity of the Raman excitation light output in the excitation light output procedure as the intensity of the Raman excitation light before propagation through the transmission line fiber, and measures the intensity of the Raman excitation light having returned as return light from the transmission line fiber as the intensity of the Raman excitation light after propagation through the transmission line fiber.

The distributed Raman amplification apparatus, the distributed Raman amplification method, and the distributed Raman amplification program according to the exemplary embodiments of the present invention may be applied to obtain the desired Raman gain and the desired signal light intensity by monitoring the Raman gain in real time even when the transmission line loss and the Raman gain vary due to seasonal variations and the like, in a wavelength-division multiplexing system and the like.

Given process in the above-described exemplary embodiments may be implemented by causing a CPU (Central Processing Unit) to execute a computer program. In this case, the computer program can be stored and provided to a computer using any type of non-transitory computer readable medium. The non-transitory computer readable medium includes any type of tangible storage medium. Examples of the non-transitory computer readable medium include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable medium. Examples of the transitory computer readable medium include electric signals, optical signals, and electromagnetic waves. The transitory computer readable medium can provide the program to a computer via a wired communication line (e.g. electric wires, and optical fibers) or a wireless communication line.

The present invention can provide a technique that allows real-time monitoring of the Raman gain.

What is claimed is:

1. A distributed Raman amplification apparatus comprising:
a Raman excitation light source that outputs Raman excitation light to a transmission line fiber through which signal light propagates;
a light source control unit that controls an output wavelength of the Raman excitation light source to prevent the Raman excitation light from changing a wavelength spectrum of the signal light;
an intensity measurement unit that measures intensity of the Raman excitation light before and after propagation through the transmission line fiber; and
a loss calculation unit that calculates a loss of the Raman excitation light in the transmission line fiber based on the intensity of the Raman excitation light before and after propagation through the transmission line fiber measured by the intensity measurement unit.

2. The distributed Raman amplification apparatus according to claim 1, further comprising:
a Raman gain control unit that controls a Raman gain of the transmission line fiber based on the loss of the Raman excitation light in the transmission line fiber calculated by the loss calculation unit.

3. The distributed Raman amplification apparatus according to claim 1, further comprising:
a wavelength spectrum measurement unit that measures a wavelength spectrum of wavelength-multiplexed signal light,
wherein the light source control unit controls an output wavelength of the Raman excitation light source to prevent the Raman excitation light from changing the wavelength spectrum of the wavelength-multiplexed signal light based on the wavelength spectrum of the wavelength-multiplexed signal light measured by the wavelength spectrum measurement unit.

4. The distributed Raman amplification apparatus according to claim 1, wherein
the light source control unit modulates the intensity of the Raman excitation light,
the intensity measurement unit measures the modulated intensity of the Raman excitation light before and after propagation through the transmission line fiber, and
the loss calculation unit calculates a loss of the Raman excitation light in the transmission line fiber based on the modulated intensity of the Raman excitation light before and after propagation through the transmission line fiber measured by the intensity measurement unit.

5. The distributed Raman amplification apparatus according to claim 1, wherein the intensity measurement unit measures the intensity of the Raman excitation light output from the Raman excitation light source as the intensity of the Raman excitation light before propagation through the transmission line fiber, and measures the intensity of the Raman excitation light having returned as return light from the transmission line fiber as the intensity of the Raman excitation light after propagation through the transmission line fiber.

6. A distributed Raman amplification method comprising:
controlling an output wavelength of Raman excitation light to prevent the Raman excitation light from changing a wavelength spectrum of signal light;
outputting the Raman excitation light with the controlled output wavelength to a transmission line fiber through which the signal light propagates;
measuring intensity of the Raman excitation light before and after propagation through the transmission line fiber; and
calculating a loss of the Raman excitation light in the transmission line fiber based on the measured intensity of the Raman excitation light before and after propagation through the transmission line fiber.

7. The distributed Raman amplification method according to claim 6, further comprising, after calculating a loss of the Raman excitation light in the transmission line fiber, controlling a Raman gain of the transmission line fiber based on the calculated loss of the Raman excitation light in the transmission line fiber.

8. A non-transitory computer readable medium storing a distributed Raman amplification program causing a computer to execute a process comprising:
controlling an output wavelength of Raman excitation light to prevent the Raman excitation light from changing a wavelength spectrum of signal light;
outputting the Raman excitation light with the controlled output wavelength to a transmission line fiber through which the signal light propagates;
measuring intensity of the Raman excitation light before and after propagation through the transmission line fiber; and
calculating a loss of the Raman excitation light in the transmission line fiber based on the measured intensity of the Raman excitation light before and after propagation through the transmission line fiber.

9. The non-transitory computer readable medium storing a distributed Raman amplification program according to claim 8, the program causing the computer to further execute, after calculating a loss of the Raman excitation light in the transmission line fiber, controlling a Raman gain of the transmission line fiber based on the calculated loss of the Raman excitation light in the transmission line fiber.
